(19) United States
(12) Patent Application Publication
(10) Pub. No.: US 2008/0045632 A1
(43) Pub. Date: Feb. 21, 2008

(54) Method for preventing blocking and deterioration in flowability of epoxy molding compound powder

(76) Inventors: Jeong Yong Jo, Yongin-si (KR); Kyung Dae Kim, Suwon-si (KR); Hee Woo Woo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/645,513

(22) Filed: Dec. 27, 2006

(30) Foreign Application Priority Data
Aug. 21, 2006 (KR) 10-2006-0078999

(51) Int. Cl. C08L 63/00; C08K 7/00; B32B 27/38

(52) U.S. Cl. 523/400

(57) ABSTRACT

A method for preparing an epoxy molding compound powder includes preparing an epoxy molding compound chips, feeding dry ice into a dry ice consecutive feeder to form dry ice chips, grinding simultaneously the epoxy molding compound chips and the dry ice chips in a grinder to form a powder mixture, and separating the powder mixture to form epoxy molding compound powder.

### BACKGROUND OF THE INVENTION

1. Field of the Invention

The present invention relates to a method of forming epoxy molding compound powder. More specifically, the present invention relates to a method for preventing blocking and deterioration in flowability of an epoxy molding compound powder by employing dry ice during grinding thereof.

2. Description of the Related Art

In general, epoxy molding compounds (“EMCs”) may refer to thermosetting composite materials formed of epoxy resins and additives, e.g., hardeners, hardening accelerators, fillers, coupling agents, colorants, release agents, and so forth, that may be used to seal and/or encapsulate semiconductor devices and other electrical components.

The conventional EMCs may be prepared by mixing an epoxy resin with at least one additive into a homogeneous mixture, milling the mixture by transfer and shear stress of screws and paddles, and melt-kneading or grinding the milled mixture into a predetermined form and size, e.g., powder, tablets, and so forth, with respect to the EMC intended use.

However, conventional grinding of EMCs may generate latent heat and, thereby, increase the overall temperature of the EMCs. Subjecting EMCs to a temperature above a predetermined value may harden the EMCs and, thereby, provide a hard and insoluble material that cannot be softened or reshaped upon reheating. Such hardening of EMC may cause blocking and deteriorate flowability of EMC powders. Moreover, such blocking and deteriorated flowability may be further increased when the EMC powders are prepared from a resin having a low viscosity. Blocked powders with deteriorated flowability may cause defects in subsequent tabletting and/or molding processes or even terminate such processes completely, i.e., excessively blocked powders may not be introduced into a tabletting process, thereby producing flawed electrical components. Such blocked powders may be re-powderized by a separate process; however, such a process may be performed manually, thereby causing defects due to potential adulteration from foreign materials.

In an attempt to develop a grinder capable of preventing heat generation, there has been suggested a grinder with a cooling jacket. However, such a grinder may make it difficult to maintain a temperature of the EMC powder below a critical point at which blocking thereof may occur. Therefore, there has not yet been developed a grinder which can completely prevent heat generation.

In another attempt to prevent heat generation during grinding, it has been suggested to introduce liquid nitrogen and/or an anti-blocking agent into a grinder during EMC grinding. However, use of liquid nitrogen in a grinder may trigger a safety problem upon use, high costs, difficulty in temperature control and equipment damage upon excessive use. Excessive amounts of anti-blocking agents may cause molding defects upon dispersion thereof, thereby triggering flowability deterioration, despite potential blocking prevention.

Accordingly, there is a need for a new process capable of efficiently and inexpensively removing heat generated during EMC grinding to provide minimized blocking and flow deterioration thereof.

### SUMMARY OF THE INVENTION

The present invention is therefore directed to a method for preventing blocking and deterioration in flowability of an epoxy molding compound powder, which substantially overcomes one or more of the disadvantages of the related art.

It is therefore a feature of the present invention to provide a method for preventing blocking and deterioration in flowability of an epoxy molding compound powder capable of efficiently and inexpensively removing latent heat generated during grinding thereof.

At least one of the above and other features and advantages of the present invention may be realized by providing a method for preparing an epoxy molding compound powder, including preparing an epoxy molding compound chips, feeding dry ice into a dry ice consecutive feeder to form dry ice chips, grinding simultaneously the epoxy molding compound chips and the dry ice chips in a grinder to form a powder mixture, and separating the powder mixture to form epoxy molding compound powder.

Separating the powder mixture may include removing the dry ice by sublimation. Feeding the dry ice into the dry ice consecutive feeder may include feeding dry ice into a hopper, grinding the dry ice into chips through vibrators and rotating screws, and discharging the dry ice chips through an outlet. Additionally, feeding dry ice into the dry ice consecutive feeder may include forming dry ice chips having an average diameter of about 0.01 mm to about 100 mm. The method may also include introducing the dry ice chips into the grinder at a rate of about 5 kg/min to about 100 kg/min.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a plan view of a dry ice consecutive feeder according to an embodiment of the present invention;

FIG. 2 illustrates a photograph of dry ice discharged from a dry ice consecutive feeder and supplied to a grinder according to an embodiment of the present invention;

FIG. 3 illustrates a photograph of an EMC powder obtained in Example 1; and

FIG. 4 illustrates a photograph of a blocked EMC powder obtained in Comparative Example 1.

### DETAILED DESCRIPTION OF THE INVENTION

Korean Patent Application No. 10-2006-0078999, filed on Aug. 21, 2006, in the Korean Intellectual Property Office, and entitled: “Method for Preventing Blocking and Deterioration in Flowability of Epoxy Molding Compound Powder,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

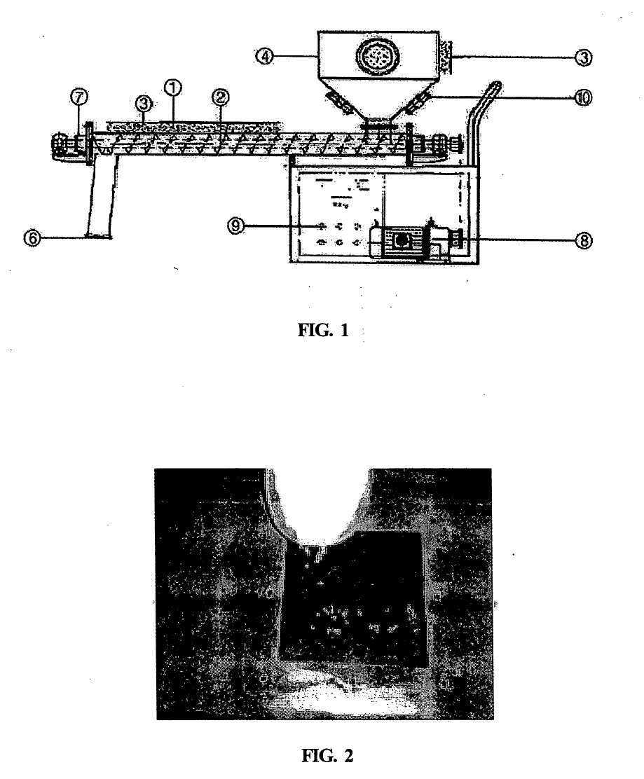

An exemplary embodiment of a method for grinding an epoxy molding compound according to the present invention may include the steps of forming dry ice chips in a feeder and grinding the dry ice chips together with EMC chips in a grinder. In particular, the dry ice feeder and its method of operation will be described in more detail with respect to FIGS. 1-2.

As illustrated in FIG. 1, a dry ice consecutive feeder according to an embodiment of the present invention may include a hopper 4, vibrators 10, rotating screws 2, an outlet 6, a coupler 7, a motor 8, a controller 9, and a lagging 1. Accordingly, dry ice may be fed into the hopper 4 and, subsequently, be transferred to the rotating screws 2 via vibration of the vibrator 10. Next, the dry ice may be ground by the rotating screws 2 and discharged through the outlet 6. The dry ice consecutive feeder may be operated via the motor 8. The hopper 4, vibrators 10, and rotating screws 2 of the dry ice consecutive feeder may be covered with the lagging 1 and a lagging cover 3 to prevent sudden sublimation of dry ice. Dry ice chips discharged from the dry ice consecutive feeder may have an average diameter of about 0.01 mm to about 100 mm.

The dry ice chips discharged from the dry ice consecutive feeder may be introduced into a separated grinder, as illustrated in FIG. 2. The dry ice chips may be introduced into the grinder at a rate of about 5 kg/min to about 100 kg/min. In particular, the dry ice chips may be introduced into the grinder with EMC chips, such that the dry ice may be present in the grinder upon grinding of the EMC chips. An initial temperature, i.e., temperature before introduction of EMC chips, inside the grinder may be maintained below a critical temperature at which powder blocking may occur. The critical temperature may vary with respect to the specific EMC resin employed, and therefore, the initial temperature may be reset before every operation.

Upon grinding, the dry ice chips and the EMC chips may be ground by the grinder into powder having an average particle diameter of about 0.01 mm to about 5 mm. Subsequently, the dry ice may be separated from the EMC powder. In particular, the dry ice may be removed by sublimation to facilitate recovery of EMC powder.

Without intending to be bound by theory, it is believed that the presence of the dry ice chips with the EMC chips in the grinder may facilitate temperature regulation of latent heat generated during EMC grinding, thereby maintaining an overall temperature inside the grinder at a desired level, i.e., a temperature not exceeding a critical temperature at which powder blocking occurs. Such control of temperature may prevent EMC hardening, thereby minimizing powder blocking and flowability deterioration thereof.

### EXAMPLES

### Example 1

An EMC was prepared by mixing a biphenyl epoxy resin, a xylok-type hardener, and additional additives into a homogenous mixture. Next the mixture was melt-milled. Subsequently, the melt-milled mixture was processed into a thin plate and pre-ground to form EMC chips. The critical temperature of the EMC powders was 15 to 20° C.

Dry ice was ground in a dry ice consecutive feeder and fed with the EMC chips into a grinder. The flow rate of dry ice into the grinder was 20-30 kg/hr, and the flow rate of EMC chips into the grinder was 300 kg/hr. The dry ice and the EMC chips were ground in the grinder into powder. The dry ice was removed by sublimation, thereby enabling recovery of EMC powder.

The dry ice consecutive feeder employed was the same grinder described with respect to FIG. 1.

### Comparative Example 1

EMC powder was prepared in the same manner as described in Example 1, with the exception that the EMC chips were introduced into the grinder without dry ice.

Each EMC powder prepared in Example 1 and Comparative Example 1 was analyzed in terms of blocking and deterioration in flowability.

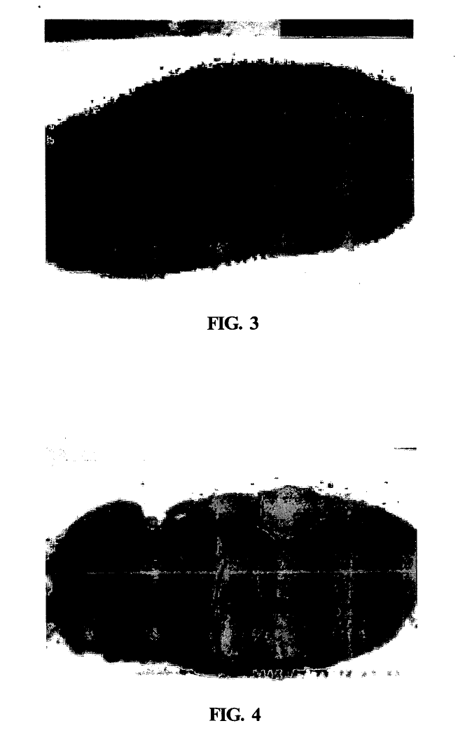

Blocking of EMC powders was tested with respect to a determination whether the recovered EMC powder could be manually crushed, i.e., with hands, into finer powder particles to minimize aggregation, i.e., presence of particles aggregated into bigger clumps and maintained as such due to friction forces therein. Recovered EMC powder that could not be crushed was determined as “blocked,” and recovered EMC powder that could be crushed was determined as “unblocked”. The results are shown in Table 1 and FIGS. 3-4.

TABLE 1

| | | Average temperature of |
|---|---|---|
| Item | Result | prepared EMC powder (° C.) |
| Example 1 | Unblocked | 10 |
| Comparative Example 1 | Blocked | 25 |

Deterioration in flowability of EMC powders was evaluated based on the difference between the spiral flow value of EMC powders measured immediately after preparation and the spiral flow value of EMC powders measured one day after preparation. Each spiral flow value was determined by averaging the values measured three times independently. The spiral flow value of each EMC powder, i.e., both Example 1 and Comparative Example 1, measured immediately after preparation was 45 inch. The spiral flow value was measured using a test mold according to the standard of EMMI-1-66 at 175° C. with a transfer molding press. The results are shown in Table 2.

TABLE 2

| | Example 1 | |
|---|---|---|
| | Deterioration | Comparative Example 1 |
| No. | in flowability (inch) | Deterioration in flowability (inch) |
| 1 | 0.7 | 2.8 |
| 2 | 1.0 | 2.1 |
| 3 | 1.1 | 2.9 |
| 4 | 0.5 | 2.6 |
| 5 | 0.5 | 3.6 |
| 6 | 0.6 | 4.2 |
| Avg. | 0.7 | 3.0 |

As shown in Tables 1-2 and FIGS. 3-4, the method of the present invention may provide minimized powder blocking as well as enhanced powder flowability. Further, the method of the present invention may improve the distribution degree of flowability deterioration.

As apparent from the above description, preparation of EMC powders by employing dry ice from a dry ice consecutive feeder may provide improved removal of latent heat in the grinder and, thereby, minimize powder blocking and flowability deterioration of EMC Accordingly, use of dry ice may reduce product defects. Furthermore, the use of dry ice may provide enhanced efficiency of heat removal, improved temperature control, reduced operational costs, and increased process stability by minimizing potential accidents, e.g., as compared to a method employing liquid nitrogen.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A method for preparing an epoxy molding compound powder, comprising:
preparing epoxy molding compound chips;
feeding dry ice into a dry ice consecutive feeder to form dry ice chips;
grinding simultaneously the epoxy molding compound chips and the dry ice chips in a grinder to form a powder mixture; and
separating the powder mixture to form epoxy molding compound powder.

2. The method as claimed in claim 1, wherein separating the powder mixture includes removing the dry ice by sublimation.

3. The method as claimed in claim 1, wherein feeding the dry ice into the dry ice consecutive feeder includes feeding dry ice into a hopper, grinding the dry ice into chips through vibrators and rotating screws, and discharging the dry ice chips through an outlet.

4. The method as claimed in claim 1, wherein feeding dry ice into a dry ice consecutive feeder includes forming dry ice chips having an average diameter of about 0.01 mm to about 100 mm.

5. The method as claimed in claim 1, further comprising introducing the dry ice chips into the grinder at a rate of about 5 to about 100 kg/hr.
